(19) United States
(12) Patent Application Publication
(10) Pub. No.: US 2015/0204304 A1
(43) Pub. Date: Jul. 23, 2015

(54) WAVE ENERGY CONVERTER

(71) Applicant: OCEAN HARVESTING TECHNOLOGIES AB, Karlskrona (SE)

(72) Inventors: Mikael SIDENMARK, Karlskrona (SE); Torbjörn ANDERSSON, Karlskrona (SE)

(21) Appl. No.: 14/674,126

(22) Filed: Mar. 31, 2015

Related U.S. Application Data
(63) Continuation of application No. PCT/SE2013/051176, filed on Oct. 7, 2013.

(30) Foreign Application Priority Data
Oct. 5, 2012 (SE) 12511331-7

(51) Int. Cl. F03B 13/22

(52) U.S. Cl. CPC F03B 13/22

(57) ABSTRACT

A wave energy converter comprises an energy absorption unit arranged to absorb energy generated by movements of water, a power smoothing unit, a power generation unit and an energy storage device, these units being adapted to cooperate to achieve a smooth power output from the power generation unit. The power smoothing unit is arranged to accumulate energy from the energy absorption unit in the energy storage device when the energy absorption unit absorbs more power than the power generation unit generates and to release energy from the energy storage device to the power generation unit when the energy absorption unit absorbs less energy than the power generation unit generates.

### TECHNICAL FIELD

The present invention relates to a wave energy converter for producing electric energy from movements of water waves, and a method for producing electric energy from more or less intermittent mechanical energy, such as more or less periodical movements of a body.

### BACKGROUND ART

Wave energy is a concentrated form of renewable energy that comes from the friction between the water surface and the wind. The energy is built up by the wind on the open seas and then transported to locations closer to the shore, where it can be extracted with wave energy converters. Due to the high energy density of ocean waves, wave power is very area efficient and the average energy content changes more slowly and predictably compared to, for example, the wind. The resources are vast and can be harvested close to populated areas.

One of the difficulties with harvesting wave energy is that waves vary so much in height and frequencies even within a given sea-state. The larger waves contain a significant share of the total energy but occur less frequently than the smaller. The energy peaks from the large waves lead to high peak-to-average power ratios. The system has to be dimensioned for the peaks, leading to higher investment cost. To avoid this, wave energy converters use power smoothing to enable these high peaks of energy to be utilized without the need to oversize the power take-off and electrical system. The leading wave power device developers use a variety of power smoothing devices.

When selecting and comparing energy storage devices, it is important to consider the energy and power ratings of the storage device and how it influences power capture capabilities, system efficiency, component sizing and system reliability. Wave power is captured in pulses whereby a high power rating of the storage device is very important. The captured power is intermittent with peak-to-average power ratios in the range of 10 in any given sea state. The energy rating only need to be sufficient to smooth power over a few consecutive waves in order to provide a smooth output power from a given sea state. The location of the storage device and its characteristics influences the WEC system ability to capture power. It is essential that the storage device is located in the power take-off before the generator, to enable the generator to operate efficiently and to reduce the sizing of components through the electrical system. This location will also decouple the generator from the energy absorption unit in the WEC system and thus it's characteristics and capabilities to control the damping force applied to the energy absorption unit will influence power capture.

A gravity accumulator has a favorable characteristics compared to a gas or spring accumulator. The damping force provided by a gravity accumulator to the energy absorption unit will only be influenced by the inertia of the weight in the accumulator and not the level of stored energy, as is the case with a spring or gas accumulator. A gravity accumulator thus has the capability to maintain the damping force on a smoother level compared to a gas or spring accumulator, which provides better power capture capabilities and utilization of component ratings in the power take-off. The gravity accumulator is also implemented with mechanical components which operate more efficiently with the highly variable power content compared to hydraulic components which are used in the case of gas accumulators. Third type of storage device that can be used in the power take-off is a flywheel, but this type of accumulator is very difficult to use for wave power due to the high variability of mechanical input velocity to the power take-off. It is difficult to keep the flywheel coupled with the wave motion at the same time as it provides a reduced speed variability to the generator. A variable gear box with an infinite gear range is required between the energy absorption unit and the flywheel to achieve this. Existing solutions for variable gearboxes are however limited in gear range and suffers from poor efficiency, especially when continuously cycling the gear ratio over wide ranges.

A Wave Energy Converter using a mechanical power take-off with a gravity accumulator has been shown in the international patent publication No. WO 2009/105011, which provides the required capabilities for high performance power smoothing as described above.

### SUMMARY OF INVENTION

An object of the present invention is to provide a wave energy converter with improved mechanical power take-off with a gravity accumulator.

According to a first aspect of the present invention, a wave energy converter is provided comprising an energy absorption unit to absorb energy generated by movements of water when the wave energy converter is arranged in a pool of water, a power smoothing unit, a power generation unit arranged to produce power, and an energy storage device arranged to store mechanical energy, wherein the power smoothing unit is arranged to store and retrieve energy from the energy storage device; wherein the energy absorption unit, the power smoothing unit, the power generation unit and the energy storage device are adapted to cooperate, and wherein the power smoothing unit is arranged to accumulate energy from the energy absorption unit in the energy storage device when the energy absorption unit absorbs more power than the power generation unit generates and to dissipate energy to the power generation unit when the energy absorption unit absorbs less power than the power generation unit generates, the wave energy converter being characterized by a first transmission device adapted to transfer energy absorbed by the energy absorption unit to the power smoothing unit and/or the power generation unit and a second transmission device adapted to transfer energy from the power smoothing unit to the energy storage device.

In a preferred embodiment, the first transmission device comprises a mechanical rectifier connected to the power smoothing unit, and/or the power generation unit.

In a preferred embodiment, the first transmission device comprises at least one hydraulic pump to a hydraulic turbine/motor system where the flow generated from the at least one hydraulic pump is rectified by valves that creates a unidirectional rotation of the hydraulic turbine/motor.

In a preferred embodiment, the first transmission device comprises any of the following: a rack and pinion, a chain and chain pinion, a ball/roller screw, a lever shaft and a winch system.

In a preferred embodiment, the energy absorption unit comprises a pipe or chamber with a fluid, such as water or air, and a turbine, preferably a Wells turbine.

In a preferred embodiment, the second transmission device comprises any of the following: a rack and pinion, a chain and chain pinion, a ball/roller screw, a lever shaft and a winch system.

In a preferred embodiment, the energy storage device comprises any of the following: a counterweight, a mechanical spring, a hydraulic spring, a hydraulic spring, and a pneumatic spring.

In a preferred embodiment, the power smoothing unit and the power generation unit are located on a separate offshore platform, preferably a floating structure.

In a preferred embodiment, the power smoothing unit and the power generation unit are located offshore in a structure firmly fixed to the sea floor.

In a preferred embodiment, the power smoothing unit and the power generation unit are located onshore.

In a preferred embodiment, the wave energy converter comprises a first housing enclosing a power smoothing unit and the power generation unit.

In a preferred embodiment, the energy storage device is a weight which is guided on a linear guide inside a second housing.

In a preferred embodiment, the first and second housings are firmly but preferably detachably attached to each other.

In a preferred embodiment, the wave energy converter comprises a plurality of energy absorption units connected to a common fluid collection system, of which each energy absorption unit contributes to pump fluid to a common hydraulic motor connected to the power smoothing unit and/or the power generation unit, wherein the energy absorption units are located in separate locations to the power smoothing unit and/or the power generation unit.

In a preferred embodiment, the energy storage device and the second transmission device are located in an extended housing from a housing of the power smoothing unit and/or the power generation unit, that separates the energy storage device and the second transmission device from the surrounding environment.

### BRIEF DESCRIPTION OF DRAWINGS

The invention is now described, by way of example, with reference to the accompanying drawings, in which:

FIG. 1 is a block diagram showing the overall layout of a wave energy converter system comprising an energy absorption unit, a power take-off with a power smoothing unit and a power generation unit according to the invention;

FIG. 2 is a diagram explaining the general operation of a wave energy converter with a power smoothing unit comprising a three way gearbox according to the invention;

FIG. 3 is a diagram explaining the general operation of a wave energy converter with the power smoothing unit comprising a generator with two individually rotating parts according to the invention;

FIGS. 4-5 show a wave energy converter system with different hydraulic embodiments of the first transmission device showing unidirectional and bidirectional power capture of the energy absorption unit according to the invention;

FIG. 6 shows different types of energy absorption units located offshore that transfer captured power by pumping a fluid to the power smoothing unit and power generation which are located onshore;

FIGS. 7-9 show details of a wave energy converter with different combinations of energy absorption units and transmission devices to the power smoothing unit, and a rack and pinion transmission between the power smoothing unit and the energy storage device;

FIGS. 10a and 10b are diagrams showing a lever shaft transmission between the energy storage device and the energy storage device;

FIG. 11 is a diagram showing an alternative embodiment with a spring accumulator according to the invention;

FIG. 12 is a diagram showing an embodiment wherein a plurality of energy absorption units are connected to the power smoothing unit according to the invention; and

FIG. 13 is a diagram showing an embodiment wherein the energy storage device and transmission device to the power smoothing unit is located in a housing.

### DESCRIPTION OF EMBODIMENTS

In the following, a detailed description of various embodiments of a wave energy converter will be given. In this description, the term “pool of water” should be taken to include any body or mass of water. Also, by the term “transmission device” is meant a device that converts a rotational motion into a translational motion or vice versa, or transfers a rotational motion from one part of the system to another part. Furthermore, in some instances the term “power” and “energy” are used interchangeably, such as “power absorption” and “energy absorption”.

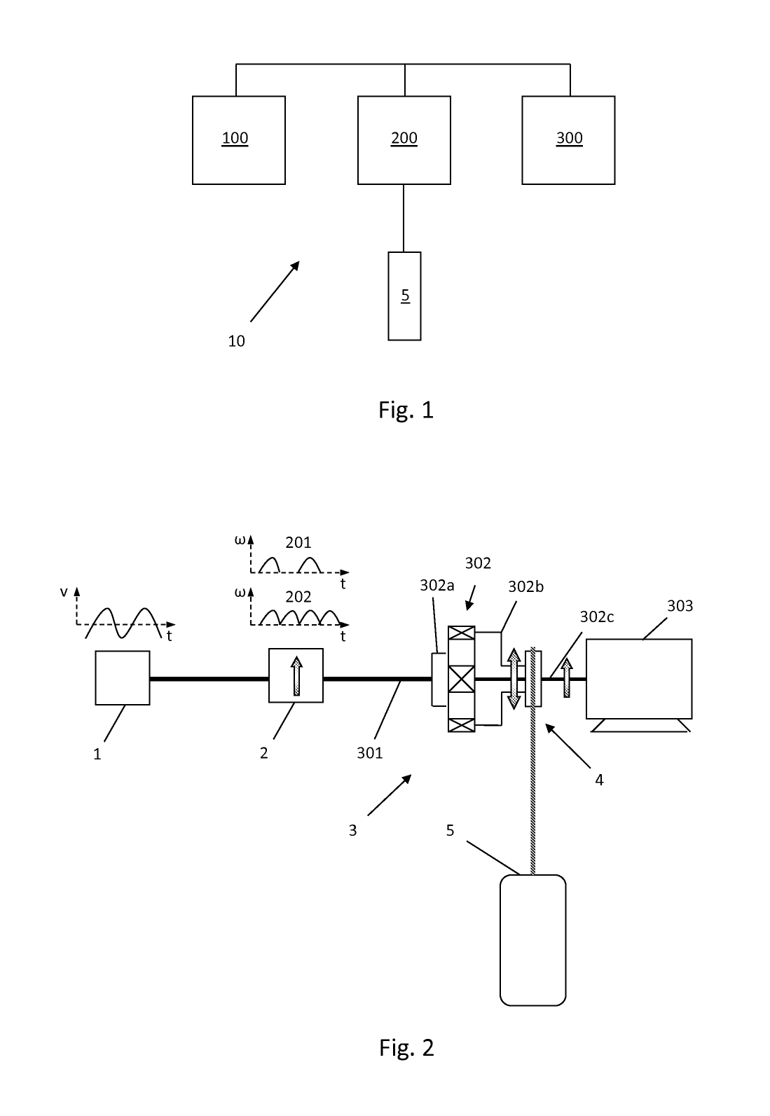

Referring to FIG. 1, a wave energy converter according to the invention comprises a power or energy absorption unit 100, commonly called “prime mover”, an energy accumulation unit in the form of a power smoothing unit 200, a power generation unit 300 and an accumulator or energy storage device 5, where the power smoothing unit 200 is connected between the energy absorption unit 100, the power generation unit 300 and the energy storage device 5. Some or all of these units may be arranged in a floating structure or buoy offshore, or a fixed structure offshore or onshore or in another type of wave energy conversion system (not shown in the figures). These four units are adapted to cooperate with each other in such a way that the highly fluctuation power captured by the energy absorption unit is smoothed by the power smoothing unit, in such a way that the power generation unit generates power on a close to constant level.

The energy absorption unit 100 is arranged to absorb energy generated by movements of water when the wave energy converter is arranged in a pool of water. This can be achieved for example by an arrangement connecting the energy absorption unit to a fixed point of reference, e.g. the seabed, or a relative point of reference, e.g. a second body of the wave energy converter, or other arrangement. In the upward and downward movements of the water surface the buoy 20 is made to alternately rise or sink and/or alternately rock or tilt back and forth. Thereby a motive force can be created in relation to the bottom of the pool of water or a second body of the wave energy converter. It should also be appreciated that the energy absorption unit 100 may comprise a device absorbing energy from water currents in a sea or a river, for example.

The power smoothing unit 200 is arranged to store or accumulate energy from the energy absorption unit 100 in the energy storage device 5 when the energy absorption unit absorbs more power than the power generation unit 300 generates, and to retrieve energy from the energy storage device to the power generation unit 300 when the energy absorption unit absorbs less power than the power generation unit 300 generates. The energy storage device may for example store energy as potential energy in a counterweight, which provides a nearly constant torque that only changes slightly due to inertia effects in moving and rotating parts of the system. In this way, the power output of the wave energy converter can be maintained essentially constant, despite varying power absorption and level of stored energy in the energy storage device.

This general principle will now be described in connection with an embodiment shown in FIG. 2. The oscillating wave motion is captured by an energy absorption unit in the form of a wave activated body 1 and converted to a unidirectional rotational motion in the first transmission device 2, which is connected to input shaft 301 of the gearbox and generator assembly 3, comprising the power smoothing unit and the power generation unit. Input shaft 301 is connected to a planet carrier shaft 302a in a planetary gearbox 302. The ring gear shaft 302b of the planetary gearbox is connected to second transmission device 4 that converts the rotation of the ring gear shaft to a heaving motion of an energy storage device in the form of counterweight 5. The sun gear shaft 302c of the planetary gearbox is connected to the generator 303.

The wave activated body 1 may be single-acting or double-acting. In the case of a single-acting wave activated body, first transmission device 2 will generate a unidirectional rotation with the characteristics according to 201, i.e. the input shaft 301 will be rotated in one direction and blocked from rotating in the other direction by the first transmission device 2. In the case of a double-acting wave activated body, the first transmission device 2 will generate a unidirectional rotation with the characteristics according to 202, i.e. one of the motion directions from the wave activated body 1 is inverted so that the rotational direction of input shaft 301 is the same independently of the motion direction of the wave activated body.

The first transmission device 2 typically comprises a pulley, a winch, chain, ball/roller screw, lever shaft or a rack and pinion and a mechanical rectifier, or a hydraulic pump and turbine system in which the flow generated from the hydraulic pump is rectified by valves to create a unidirectional rotation of a preferably hydraulic turbine/motor.

The second transmission device 4 can typically be a pulley, a winch, chain, ball/roller screw or a rack and pinion or any other type of device that converts the rotation of the ring gear shaft 302b into a heaving motion.

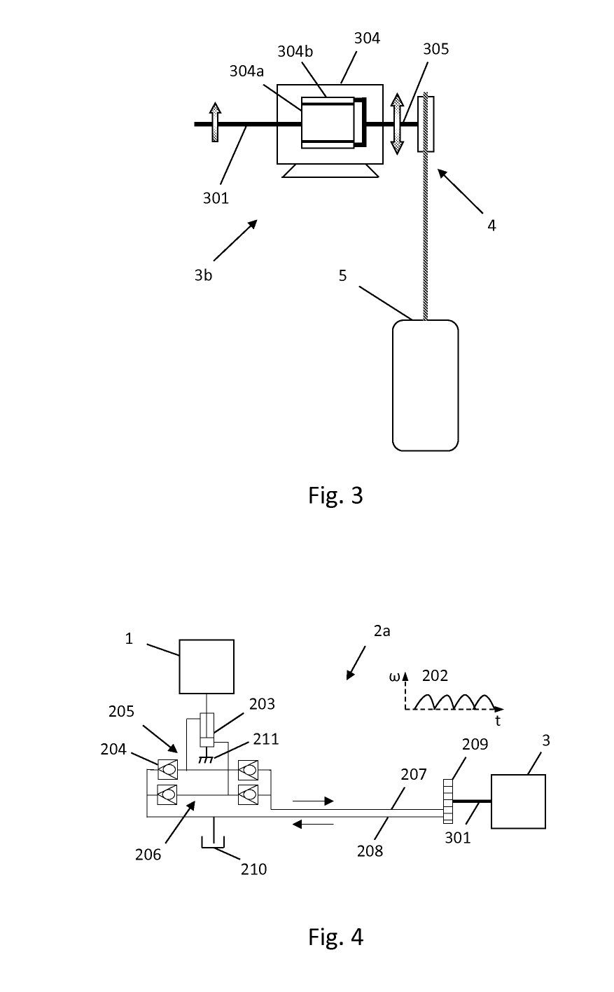

An alternative configuration of the gearbox and generator assembly 3b is shown in FIG. 3 and comprises the input shaft 301 which is connected to the rotor 304a of the generator 304. The stator 304b is connected to a second shaft 305 of the generator which is connected to the second transmission device 4.

The function and power smoothing capabilities of this configuration is equivalent with the other configuration where a planetary gearbox is used in combination with a single shafted generator.

In the embodiment shown in FIG. 4, the first transmission device 2 includes a double-acting hydraulic pump and hydraulic turbine/motor device 2a, where the wave activated body 1 is connected to a hydraulic double-acting cylinder 203. When the piston of the hydraulic cylinder 203 is pulled by the wave activated body, a high pressure flow exits a first chamber of the hydraulic cylinder and is directed by two backstop valves 204 in circuit 205 to the high pressure pipe 207, while low pressure fluid enters the second chamber of the hydraulic cylinder, which is directed from the low pressure pipe 208 by the two back stop valves 204 in circuit 206. When the piston of the hydraulic cylinder 203 is pushed by the wave activated body, a high pressure flow exits the second chamber of the hydraulic cylinder and is directed by two backstop valves 204 in circuit 206 to the high pressure pipe 207, while low pressure fluid enters the first chamber of the hydraulic cylinder, which is directed from the low pressure pipe 208 by the two back stop valves 204 in circuit 205. Circuit 205 and 206 together creates a flow in one direction through the high pressure pipe 207 to turbine/motor 209 and a flow in one direction back to circuit 205 and 206 through the low pressure pipe 208. Turbine/motor 209 thus gives a unidirectional rotation on the input shaft 301 to the power take off assembly 3 with the characteristics described by 202. 210 is a fluid reservoir connected to the low pressure pipe 208. 211 is a point that counteracts the movement of the wave activated body 1, typically a sea floor foundation or a second body of the wave energy converter.

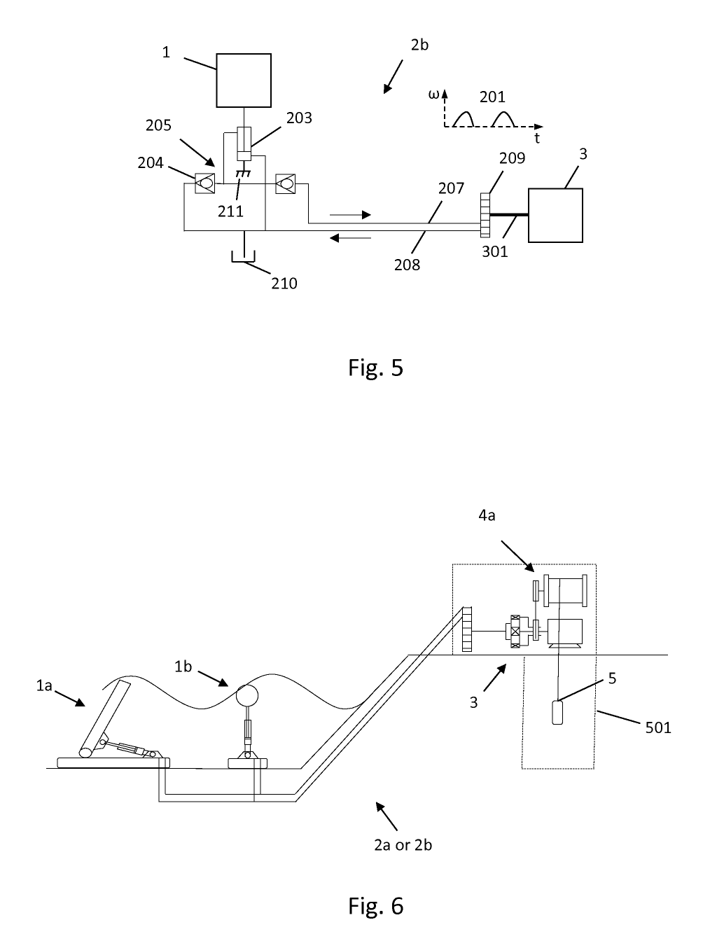

In another embodiment, shown in FIG. 5, the first transmission device 2 includes a single acting hydraulic pump and turbine/motor device 2b, in which the wave activated body 1 is connected to a hydraulic single-acting cylinder 203. When the piston of the hydraulic cylinder 203 is pulled by the wave activated body, a high pressure flow exits a first chamber of the hydraulic cylinder, which is directed to the high pressure pipe 207 by the two back stop valves 204 in circuit 205, while low pressure fluid from the low pressure pipe 208 enters the second chamber of the hydraulic cylinder. In the opposite direction of the wave activated body, the piston of the hydraulic cylinder 203 is pushed back by a spring mechanism or similar whereby low pressure fluid enters the first chamber, which is directed from the low pressure pipe 208 by the back stop valves 204 in circuit 205, while at the same time hydraulic fluid exits the second chamber to the low pressure pipe 208. Back stop valves 204 in circuit 205 prevents back flow in the high pressure pipe and the Turbine/motor 209 thus prevents the input shaft 301 to the power take off assembly 3 to rotate in the opposite direction and thereby gives an intermittent unidirectional rotation with the characteristics described by 201. 210 is a fluid reservoir connected to the low pressure pipe 208. 211 is a point that counteracts the movement of the wave activated body 1, typically a sea floor foundation or a second body of the wave energy converter.

In another embodiment, shown in FIG. 6, a wave energy converter system is shown comprising two different types of wave energy absorption devices at a distance from but connected to a single power take-off and generator assembly 3, i.e. the power smoothing unit and the power generation unit are located separately from the energy absorption unit. The expressions “at a distance from” and “separately” should be interpreted as the energy absorption units acting as individual units connected to a central unit comprising the power smoothing unit and the power generation unit in a separate housing. The shown energy absorption units are of surging type 1a, such as a hinged flap or similar that sways with the wave motion, and a heaving type 1b, such as a buoy that heaves with the wave motion, but could be any other type and or number that follow the wave motion to give a translational or rotational input motion to the first transmission device 2a or 2b. Typically a plurality of a single type of energy absorption units will be used in a given wave energy converter system. First transmission device 2a or 2b converts the oscillating motion into a unidirectional rotation input to the gearbox and generator assembly 3. Second transmission device 4 in this configuration is a winch system 4a, but can also be a pulley, chain, ball/roller screw, rack and pinion or any other type that converts a rotation into a heaving motion of the counterweight 5.

In the shown configuration, the gearbox and generator assembly 3 is located onshore in which case the counterweight moves in a shaft 501, housing or similar. Referring to FIG. 1, this corresponds to that the power smoothing unit 200 and the power generation unit 300 are located onshore. The gearbox and generator assembly 3, the second transmission device 4 and counterweight 5 may also be located on an offshore platform which may be floating or fixed. The counterweight can then move freely in the water below the platform, or inside a housing which separates the second transmission device 4 and the counterweight 5 from the surrounding environment.

Several wave activated bodies of type 1a, 1b or any other type, single-acting or double-acting, may be connected to the same pipes in the pumped hydraulic systems 2a or 2b. A single gearbox and generator assembly 3 can thus be used for multiple energy absorption units.

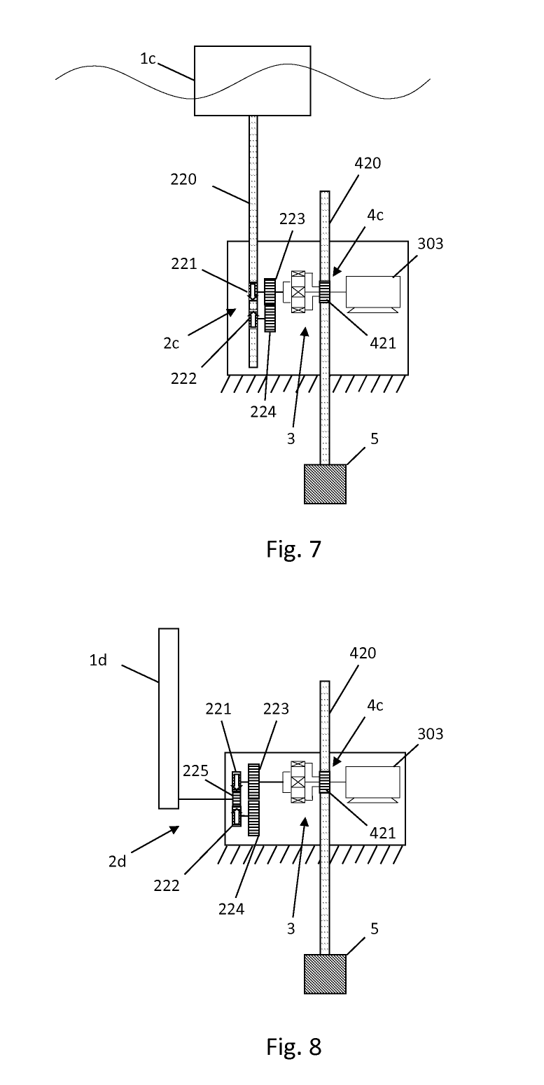

The first transmission device 2 may be a double-acting rack and pinion device 2c, see FIG. 7, in which the wave activated body 1c is connected to rack 220 which brings pinion assemblies 221 and 222 to rotate. Pinion assembly 221 comprises a pinion with a freewheel connected to the shaft of gear 223. Pinion assembly 222 comprises a pinion with a freewheel connected via gear 224 which is in tooth contact with gear 223. The direction of the freewheel in pinion assembly 221 is reversed in relation to the direction of the freewheel in pinion assembly 222, whereby the freewheel in pinion assembly 221 is engaged and rotates gear 223 in one direction when rack 220 moves upwards and the freewheel in pinion assembly 222 is engaged and rotates gear 223 in the same direction when rack 220 moves downwards. Thus the device 2c converts the double-acting oscillating motion from the wave activated body 1 into a unidirectional rotational input to the gearbox and generator assembly 3. The gearbox and generator assembly 3 is in a position to counteract the wave activated body, the counteracting position may be achieved with a heave plate, sea floor foundation, a floating rig or a rig mounted on the sea floor or any other type of structure that counteracts the motion of the wave activated body. Any type of rectifier can be used to achieve a unidirectional rotation on the input shaft 301, the shown rectifier only exemplifies this function.

The second transmission device 4 in the embodiment shown in FIG. 7 is a rack and pinion device 4c, in which the ring gear shaft in the gearbox and generator assembly 3 is connected to the shaft of pinion 421. Rack 420 is connected to pinion 421 and counterweight 5 to convert the rotary motion of the pinion to a vertical motion that lifts the counterweight.

First transmission device 2 may also be implemented as a single-acting rack and pinion device which then resembles the function of the original winch system shown in international patent publication No. WO 2009/105011.

In an alternative embodiment shown in FIG. 8, the first transmission device 2 is a double-acting direct input device 2d where the wave activated body 1d rotates the shaft connected to gear 225, which has the same function as the rack in device 2c. Pinion assemblies 221 and 222 in turn drive gear 223 to create a unidirectional rotation of the input shaft to the gearbox and generator assembly 3. The gearbox and generator assembly 3 and the second transmission device 4 may be any of the other types shown and any type of rectifier can be used to achieve a unidirectional rotation on the input shaft 301, the shown rectifier only exemplifies this function.

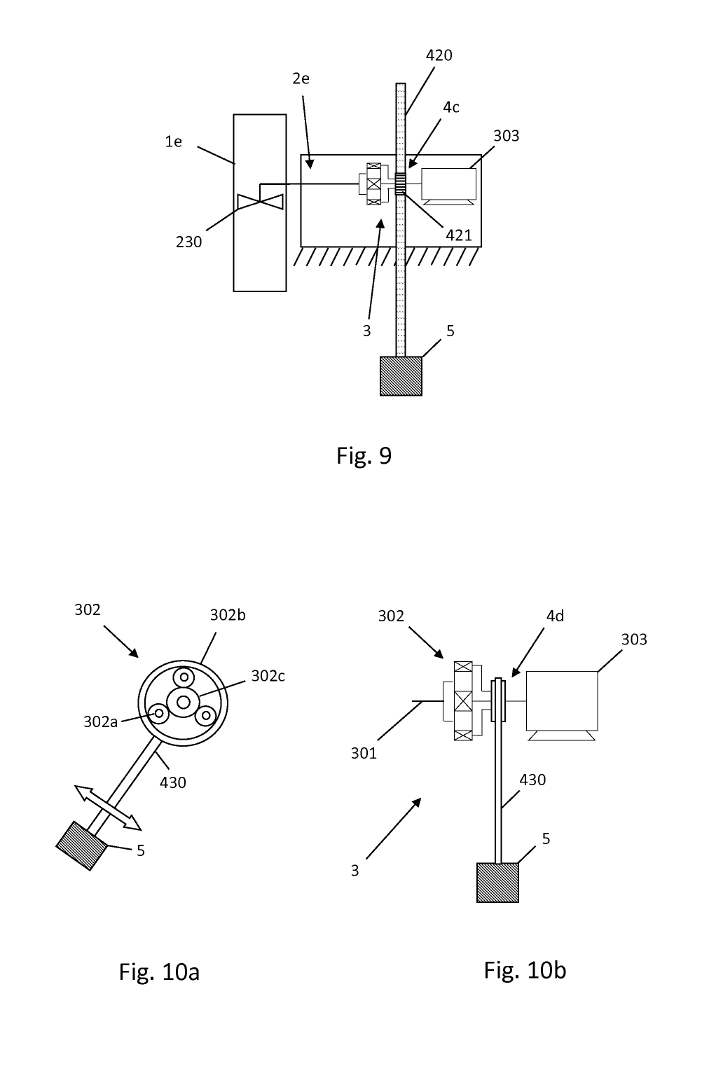

In yet an alternative embodiment shown in FIG. 9, the wave activated body 1 is a pipe or chamber with water, air or similar that is brought to oscillate by the wave motion. Device 2e is a turbine, selected for the medium in which it operates that rotates in the same direction independently of the flow direction, such as a Wells turbine. A simpler turbine that rotates in one direction for each flow direction can also be used in combination with rectifier 2d, shown in FIG. 7, or similar.

In one embodiment, see FIGS. 10a and 10b, the second transmission device 4 comprises a counterweight lever shaft 4d attached to the ring gear 302b of the planetary gearbox 302. The torque applied to the ring gear depends on the weight of the counterweight 5 and the length and current angle of the lever shaft 430. In a similar way as the heaving motion of the counterweight is controlled by the generator speed in. e.g. device 4a shown in FIG. 6, the angle of the counterweight lever shaft is in device 4d controlled by the generator speed.

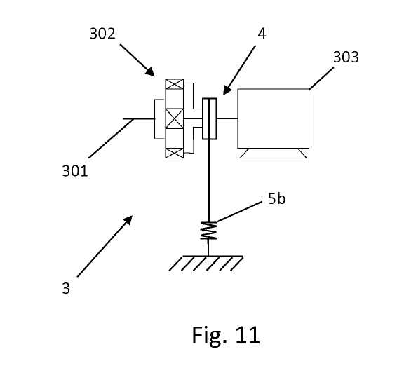

Instead of a counterweight, the energy storage device can be a mechanical, hydraulic or pneumatic spring 5b or similar accumulator device, connected to the ring gear of the planetary gearbox 302 via any type of device 4, i.e. the spring accumulator may be translationally or rotationally operated. Such an embodiment is shown in FIG. 11.

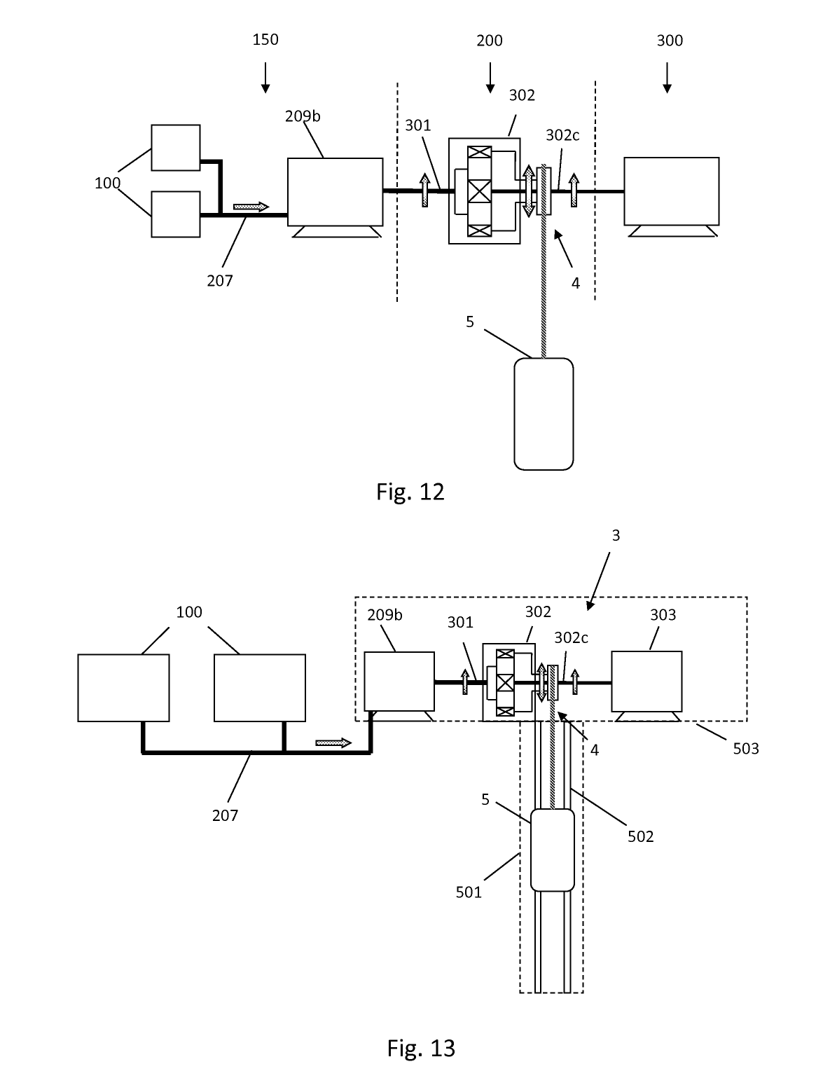

The embodiment in FIG. 12 shows a collection system 150, comprising a plurality of energy absorption units 100 connected to a common fluid pipeline 207 which is further connected to a hydraulic motor 209b, which provides a unidirectional rotational input to shaft 301 of the power smoothing unit 200, which is further connected to the power generation unit over shaft 302c and the transmission device 4 which is also connected to counterweight 5.

In the embodiment shown in FIG. 13 the energy absorption unit 100 is located separately from a first housing 503 enclosing the hydraulic motor 209b and the gearbox and the generator assembly 3. The accumulator weight or the energy storage device 5 is guided on a linear guide 502 inside a second housing 501. The transmission device 4 converts the rotary motion of the ring gear in the planetary gearbox 302 to a linear motion that lifts the counterweight 5 in the energy storage device. The first and second housings 501 and 503 are preferably firmly but preferably detachably attached to each other and can be located floating on the surface, firmly attached to the sea floor, firmly attached any structure offshore or onshore.

In summary, a wave energy converter according to the present invention has the following functionality:
A single- or double-acting energy absorption unit gives a translational or rotational oscillating movement, which is conveyed to the power take-off through a first mechanical transmission device.
Alternatively one or multiple energy absorption units give translational or rotational oscillating movements, which are conveyed to the power take-off by means of a fluid through a first hydraulic transmission device driving a hydraulic motor attached to the first shaft of the power take-off.
The first transmission device also includes a rectifier which converts the translational or rotational oscillating motion into a unidirectional rotational input motion to the power take-off.
The output shaft of the first transmission device is connected to a first shaft of a gearbox with three degrees of freedom, e.g. a planetary gearbox. A second shaft of the gearbox is connected to a generator and a third shaft is connected to a second first transmission device, which converts the rotational motion of the third shaft of the gearbox to a heaving motion of the counterweight.
Alternatively the output shaft of the first transmission device is connected directly to the generator rotor and the second first transmission device is connected via a shaft or similar to the generator stator. The function of this “two shafted” generator is the same as the assembly of a gearbox with three degrees of freedom and “single shafted” generator.
The counterweight in the energy storage device gives a close to constant torque in the system through the second transmission device to the generator and to the first transmission device, which conveys a close to constant torque, force or pressure to counteract the motion of the energy absorption unit. In the case of a single-acting energy absorption unit, the torque is only conveyed from the counterweight to the energy absorption unit when the energy absorption unit moves in the driving direction.
The translational or rotational motion conveyed from the energy absorption unit, i.e. the input velocity to the power take-off fluctuates with the wave motion, but the power smoothing unit stores and releases energy from the energy storage device in such a way that compensates for these fluctuations and provides a close to constant velocity input to the power generation unit. The speed of the generator is controlled to a close to constant level which is slowly tuned to match the average level of absorbed power. The excess input velocity is directed to rotate the second transmission device that lifts the counterweight and thereby stores potential energy. A shortage in input velocity to the power take-off will result in an opposite rotational direction of the second transmission device whereby the counterweight is lowered and thus releases potential energy.
The speed of the generator is proportional to the mechanical input torque conveyed from the counterweight and the generator damping. At a set damping coefficient, the electromagnetic torque in the generator is equal the mechanical input torque conveyed from the counterweight, at a certain speed of the generator. Thus a set damping coefficient will result in a close to constant equilibrium speed and thus close to constant power output. If the damping coefficient is altered, the equilibrium speed will change to another value and thus the power output can be controlled to match the average level of incoming energy.
In heavy conditions, absorption of wave energy is limited by disengagement of the input motion to the power take-off. Disengagement can be done by a clutch, valve or similar, typically located in the first transmission device. The disengagement of input motion is done in intervals to limit the average input velocity which prevents the generator to exceed its maximum speed and thus also power output.
In heavy conditions, absorption of wave energy can also be limited by altering the gear ratio between the energy absorption unit and the energy storage device, i.e. by altering the displacement in the hydraulic motor if the first transmission device is hydraulic, or by adding a mechanical gearbox with variable gear ratio to the first transmission device. This in turn alters the damping force provided by the energy storage device to the energy absorption unit and thus the velocity by which the weight in the energy storage device is lifted, without altering the torque provided to the power generation unit. An increased gear ratio from the energy storage device to the energy absorption unit will result in a reduced damping force to the energy absorption unit as well as a reduced velocity by which the weight is lifted in relation to the wave motion, i.e. power capture is reduced and/or limited in stronger sea states to prevent the average captured power to exceed the rated power of the device.
Altering the damping force to the energy absorption unit is also known as sea state tuning which can be used to increase the power capture, i.e. optimize the damping force for maximum power capture in each individual sea state. Typically the optimal damping force for maximum power capture increases with the increasing strength of the sea state. It is an advantage in particular to reduce the damping force from the nominal value in milder sea state to improve power capture in the more frequent and less energetic wave occurrences, which will improve the load factor of the complete system including the electrical collection system and power transmission from a wave power farm installation.

Preferred embodiments of a wave energy converter have been described. It will be appreciated that these can be varied within the scope of the appended claims without departing from the inventive idea. Thus, it will be appreciated that any combination of the shown types for the energy absorption unit 100, first transmission device 2, gearbox and generator assembly 3, second transmission device 4 and energy storage device 5 can be used.

The embodiments have described energy absorptions units adapted to absorb energy generated by movements of water, in its broadest sense these energy absorption units may also comprise tidal and wind turbines or other devices adapted to absorb energy generated by tidal streams, currents or wind.

1. A wave energy converter comprising:
an energy absorption unit arranged to absorb energy generated by movements of water when the wave energy converter is arranged in a pool of water,
a power smoothing unit,
a power generation unit arranged to produce power, and
an energy storage device arranged to store mechanical energy, wherein the power smoothing unit is arranged to store and retrieve energy from the energy storage device;
wherein the energy absorption unit, the power smoothing unit, the power generation unit and the energy storage device are adapted to cooperate, and
wherein the power smoothing unit is arranged to accumulate energy from the energy absorption unit in the energy storage device when the energy absorption unit absorbs more power than the power generation unit generates and to dissipate energy to the power generation unit when the energy absorption unit absorbs less power than the power generation unit generates,
wherein a first transmission device is adapted to transfer energy absorbed by the energy absorption unit to the power smoothing unit and/or the power generation unit, and
a second transmission device is adapted to transfer energy from the power smoothing unit to the energy storage device,
wherein the power smoothing unit and the power generation unit are located separately from the energy absorption unit.

2. The wave energy converter according to claim 1, wherein the first transmission device comprises a mechanical rectifier connected to the power smoothing unit, and/or the power generation unit.

3. The wave energy converter according to claim 1, wherein the first transmission device comprises at least one hydraulic pump and turbine/motor system where a flow generated from the hydraulic pump is rectified by valves that create a rotation of the turbine.

4. The wave energy converter according to claim 1, wherein the first transmission device comprises any of the following: a rack and pinion, a chain and chain pinion, a ball/roller screw, a lever shaft and a winch system.

5. The wave energy converter according to claim 1, wherein the energy absorption unit comprises a pipe or chamber with a fluid, such as water or air, and a turbine.

6. The wave energy converter according to claim 1, wherein the second transmission device comprises any of the following: a rack and pinion, a chain and chain pinion, a ball/roller screw, a lever shaft and a winch system.

7. The wave energy converter according to claim 1, wherein the energy storage device comprises any of the following: a counterweight, a mechanical spring, a hydraulic spring, and a pneumatic spring

8. The wave energy converter according to claim 1, wherein the power smoothing unit and the power generation unit are located on a separate off-shore platform.

9. The wave energy converter according to claim 1, wherein the power smoothing unit and the power generation unit are located offshore in a structure firmly fixed to the sea floor.

10. The wave energy converter according to claim 1, wherein the power smoothing unit and the power generation unit are located onshore.

11. The wave energy converter according to claim 1, comprising a first housing enclosing a power smoothing unit and the power generation unit.

12. The wave energy converter according to claim 11, wherein the energy storage device is a weight which is guided on a linear guide inside a second housing.

13. The wave energy converter according to claim 12, wherein the first and second housings are firmly but detachably attached to each other.

14. The wave energy converter according to claim 1, comprising a plurality of energy absorption units connected to a common fluid collection system, of which each energy absorption unit contributes to pump fluid to a common hydraulic motor connected to the power smoothing unit and/or the power generation unit, wherein the energy absorption units are located in separate locations to the power smoothing unit and/or the power generation unit.

15. The wave energy converter according to claim 1, wherein the energy storage device and the second transmission device are located in an extended housing from a housing of the power smoothing unit and/or the power generation unit, that separates the energy storage device and the second transmission device from the surrounding environment.
